(19) United States
(12) Patent Application Publication
(10) Pub. No.: US 2011/0270519 A1
(43) Pub. Date: Nov. 3, 2011

(54) Apparatus and Method for Estimating Relative Location

(75) Inventors: Do Hyung Park, Seoul (KR); Eung Sun Kim, Suwon-si (KR); Joon Seong Kang, Seoul (KR)

(73) Assignee: Samsung Electronics Co.,, Suwon-si (KR)

(21) Appl. No.: 12/985,966

(22) Filed: Jan. 6, 2011

(30) Foreign Application Priority Data
Apr. 30, 2010 (KR) 10-2010-0040653

(51) Int. Cl. G01C 21/00; G01S 13/06

(52) U.S. Cl. 701/201; 342/146

(57) ABSTRACT

Provided is a method and an apparatus for estimating a distance from a target terminal, collecting route information of the apparatus and route information of the target terminal, and estimating a relative location to the target terminal based on the route information of the apparatus and the route information of the target terminal.

### CROSS-REFERENCE TO RELATED APPLICATION(S)

This application claims the benefit under 35 U.S.C. §119(a) of Korean Patent Application No. 10-2010-0040653, filed on Apr. 30, 2010, in the Korean Intellectual Property Office, the entire disclosure of which is incorporated herein by reference for all purposes.

### BACKGROUND

1. Field

The following description relates to an apparatus and a method for estimating a relative location of a target terminal, and more particularly, to an apparatus and a method for estimating a relative location from a terminal to a target terminal.

2. Description of Related Art

Methods for verifying a location of a terminal are being studied in various technical fields. Typical methods for verifying the location of a terminal include, for example, a triangulation method using a global positioning system (GPS) satellite signal or a distance between base stations. In order to perform the triangulation, the method requires a reference position where an absolute coordinate such as a base station or a satellite is known. However, the triangulation method using the GPS satellite signal or the distance between base stations may have difficulty being used indoors such as in an underground parking lot or in an underground shopping area.

In order to estimate a direction of a target terminal in a corresponding terminal indoors, a triangulation method or a direction-of-arrival (DOA) may be used.

In this example, the method for estimating a direction of the target terminal using the triangulation method may require at least two other reference terminals or reference devices in addition to the corresponding terminal and the target terminal. The method for estimating a direction of the target terminal using the DOA may require multiple antennas because an arrival direction of a direct path of a signal is estimated.

However, because a current terminal in common use may use a cellular signal or a wireless fidelity (Wi-Fi) signal, an area where a position cannot be measured using at least two access points (APs) may exist. In addition, it may be difficult to receive assistance by employing a terminal of another user as a reference terminal. Accordingly, an error may occur when using the triangulation method using the reference device. When using the DOA to estimate a direction, a signal may come from a direction that may be greatly different to from a direction of a direct path. In addition, the terminal may only be able to use a maximum of two or four antennas. This may cause a decrease in accuracy of the DOA estimation. In addition, an error may occur in the DOA estimation scheme.

### SUMMARY

In one general aspect, there is provided an apparatus for estimating a relative location, the apparatus comprising a distance estimator to estimate a distance from the apparatus to a target terminal, a route information collector to collect route information of the apparatus, and a direction estimator to receive, from the target terminal, route information of the target terminal, and to estimate a relative direction from the apparatus to the target terminal based on the route information of the apparatus and the route information of the target terminal.

The distance estimator may transmit the estimated route information of the apparatus to the target terminal.

The distance estimator may estimate the distance from the target terminal based on at least one of a time of arrival (TOA), a time difference of arrival (TDOA), and a received signal strength indication (RSSI).

The apparatus may further comprise a sensor unit to measure a moving velocity and a moving direction of the apparatus, wherein, using the sensor unit, the route information collector collects, as the route information of the apparatus, moving distance information and moving direction information of the apparatus at a predetermined time interval.

The distance estimator may estimate a distance from a reference device when the reference device exists around the apparatus, and the route information collector may collect, as the route information of the apparatus, the distance from the reference device.

The apparatus may further comprise a sensor unit to measure surrounding environment information of the apparatus, wherein the route information collector collects, as the route information of the apparatus, the surrounding environment information measured using the sensor unit.

The direction estimator may estimate a relative direction to the target terminal by comparing the surrounding environment information included in the route information of the apparatus with surrounding environment information included in the route information of the target terminal.

The direction estimator may estimate the relative direction to the target terminal using at least one algorithm of an extended Kalman filter, an unscented Kalman filter, and a particle filter that correspond to a statistical inference scheme.

The apparatus may further comprise a location estimator to estimate a relative location from the apparatus to the target terminal based on the relative distance from the target terminal and a relative direction to the target terminal, and a display unit to display the estimated relative location of the target terminal.

The location estimator may control the relative location of the target terminal based on the apparatus to be displayed in radar form on the display unit.

When an absolute location of the apparatus is verifiable, the location estimator may estimate an absolute location of the target terminal based on the estimated relative location of the target terminal.

When an absolute location of the target terminal is verifiable, the location estimator may estimate an absolute location of the apparatus based on the estimated relative location of the target terminal.

In another aspect, there is provided a method for estimating a relative location, the method comprising estimating a distance from a target terminal to an apparatus, collecting route information of the apparatus, receiving, from the target terminal, route information of the target terminal, and estimating a relative direction from the apparatus to the target terminal based on the route information of the apparatus and the route information of the target terminal.

The method may further comprise transmitting, to the target terminal, the estimated route information of the apparatus.

The estimating of the distance from the target terminal may comprise estimating the distance from the target terminal based on at least one of a TOA, a TDOA, and an RSSI.

The collecting may comprise collecting, as the route information of the apparatus, moving distance information and moving direction information of the apparatus at a predetermined time interval.

When a reference device exists around the apparatus, the collecting may comprise collecting, as the route information of the apparatus, a distance from the reference device for a predetermined time interval.

The collecting may comprise\ collecting, as the route information of the apparatus, the surrounding environment information measured using a sensor unit.

The estimating of the relative direction to the target terminal may comprise estimating the relative direction to the target terminal by comparing the surrounding environment information included in the route information of the apparatus with surrounding environment information included in the route information of the target terminal.

The estimating of the relative direction to the target terminal may comprise estimating the relative direction to the target terminal using at least one algorithm of an extended Kalman filter, an unscented Kalman filter, and a particle filter that correspond to a statistical inference scheme.

The method may further comprise estimating a relative location from the apparatus to the target terminal based on the relative distance from the target terminal and a relative direction from to the target terminal, and displaying the estimated relative location of the target terminal.

The displaying may comprise displaying the relative location of the target terminal based on the apparatus in radar form.

The method may further comprise estimating an absolute location of the target terminal based on the estimated relative location of the target terminal, when an absolute location of the apparatus is verifiable.

The method may further comprise estimating an absolute location of the apparatus based on the estimated relative location of the target terminal, when an absolute location of the target terminal is verifiable.

Other features and aspects will be apparent from the following detailed description, the drawings, and the claims.

### BRIEF DESCRIPTION OF THE DRAWINGS

FIG. 1 is a diagram illustrating an example of a terminal for estimating a relative location.

FIG. 2 is a diagram illustrating an example of estimating a relative direction.

FIG. 3 is a diagram illustrating a second example of estimating a relative direction.

FIG. 4 is a diagram illustrating a third example of estimating a relative direction.

FIG. 5 is a diagram illustrating an example of estimating a relative location in a crowd.

FIG. 6 is a flowchart illustrating an example of a method of estimating a relative location.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a to comprehensive understanding of the methods, apparatuses, and/or systems described herein. Accordingly, various changes, modifications, and equivalents of the methods, apparatuses, and/or systems described herein will be suggested to those of ordinary skill in the art. Also, description of well-known functions and constructions may be omitted for increased clarity and conciseness.

Disclosed is an apparatus and method for estimating a relative location of a target terminal that is a target for a location estimation. For example, the method may be performed by a terminal.

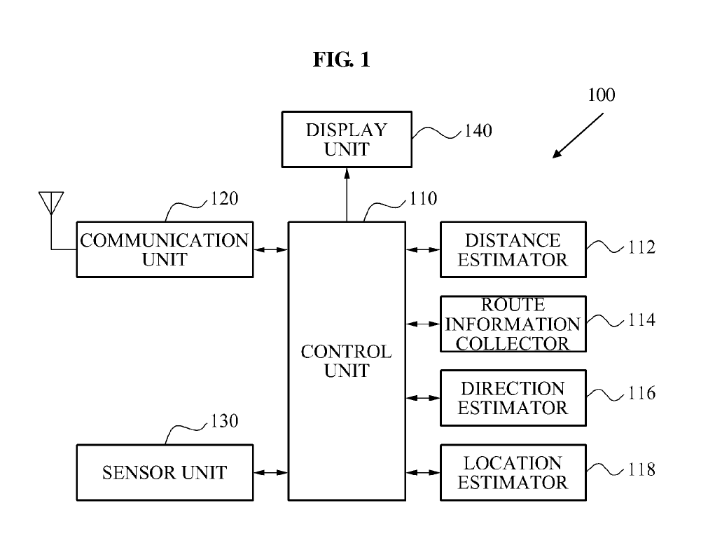

FIG. 1 illustrates an example of a terminal for estimating a relative location.

Referring to FIG. 1, the terminal 100 includes a control unit 110, a distance estimator 112, a route information collector 114, a direction estimator 116, a location estimator 118, a communication unit 120, a sensor unit 130, and a display unit 140.

When receiving a signal, the communication unit 120 may decrease a frequency of a radio frequency signal received via an antenna and may perform despreading and channel decoding of the received signal. When transmitting data, the communication unit 120 may perform channel coding and spreading of data, and may increase a frequency to transmit the data via the antenna. Accordingly, the communication unit 120 may transmit and receive a call connection request. For example, if a telephone service is provided, the communication unit 120 may transmit and receive voice data via the telephone service.

The communication unit 120 may transmit and receive a measurement signal for measuring a distance from a target terminal or a reference device. For example, the communication unit 120 may transmit and receive a measurement signal in order to measure the distance between the target terminal and the terminal 100. As another example, the communication unit 120 may transmit and receive a measurement signal in order to measure the distance between a reference device and the terminal 100. A reference device may include, for example, a base station, another terminal, and the like.

The sensor unit 130 may measure a moving velocity and a moving direction of the terminal 100. The sensor unit 130 may additionally measure surrounding environment information. For example, the surrounding environment information may include an amount of noise, a strength of a magnetic field, a temperature, a level of illumination, and the like. For example, the sensor unit 130 may include a terrestrial magnetism sensor, a gyro sensor, an acceleration sensor, a sound collection sensor, a temperature sensor, a magnetic field sensor, a photosensor, and the like.

The display unit 140 may display a relative location of the target terminal estimated by the location estimator 118. For example, the display unit 140 may employ a liquid crystal display (LCD), an organic light-emitting diode (OLED), and the like. The distance estimator 112 may estimate a distance from the target terminal using the measurement signal that is transmitted and received via the communication unit 120. For example, when the reference device exists around the terminal, the distance estimator 112 may also estimate a distance from the reference device.

For example, the distance estimator 112 may estimate the distance based on a time of arrival (TOA), a time difference of arrival (TDOA), a received signal strength indication (RSSI), and the like.

The route information collector 114 may collect route information of the terminal 100. The route information collector 114 may transmit, to the target terminal, the collected route information of the terminal 100. For example, the route information of the terminal 100 may include moving distance information of the corresponding terminal 100 and moving direction information of the terminal 100 may be estimated by the sensor unit 130. For example, the moving distance information and the moving direction information may be estimated at predetermined time intervals.

As another example, the route information of the terminal 100 may include surrounding environment information of the terminal 100. For example, the surrounding environment information may include an amount of noise, a strength of a magnetic field, a temperature, a level of illumination, and the like. As another example, when the reference device for a reference exists around the terminal 100, the route information of the terminal 100 may include a distance from the reference device to the terminal 100 estimated by the distance estimator 112.

The direction estimator 116 may estimate a relative direction from the terminal 100 to the target terminal based on the route information of the terminal 100 and the route information of the target terminal For example, the direction estimator 116 may estimate the relative direction using an algorithm of an extended Kalman filter, an unscented Kalman filter, a particle filter, and the like, that correspond to a statistical inference scheme. The direction estimator 116 may estimate a relative direction between the terminal 100 and the target terminal of the next stage, based on the route information of the terminal 100 and the target terminal.

The direction estimator 116 may estimate the relative direction based on the surrounding environment information included in the route information. For example, when a magnitude of noise that is the same as surrounding noise of the target terminal gradually increases, the direction estimator 116 may estimate that the terminal 100 is moving towards the target terminal. As another example, the direction estimator 116 may estimate the relative direction using a direction of a magnetic field of the target terminal and a direction of a magnetic field of the terminal 100. The direction estimator 116 may use the surrounding environment information included in the route information one by one, and may synthetically use all the information to estimate the relative direction.

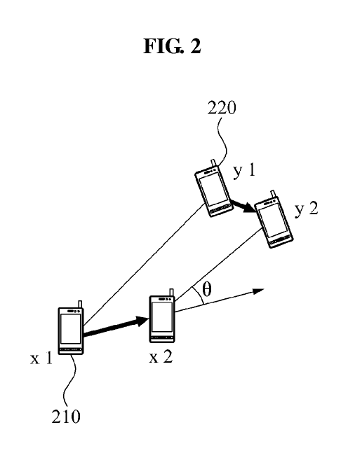

Examples of estimating a direction when a reference device does not exist, and an example of estimating a direction when the reference device does exist, are described with reference to FIG. 2 through FIG. 4.

FIG. 2 illustrates an example of estimating a relative direction.

Referring to FIG. 2, a terminal 210 may estimate route information of the terminal 210, for example, a moving distance and a moving direction of the terminal 210. For example, the moving distance information and the moving direction information may be estimated at predetermined time intervals. For example, the terminal 210 may estimate a distance and a moving direction from a position x(1) to a position x(2). As another example, a terminal 220 may estimate route information of the terminal 220, for example, a distance and a moving direction from position y(1) to a position y(2).

The terminal 210 may receive the estimated distance and the estimated moving direction of terminal 220 from the position y(1) to the position y(2) that correspond to route information estimated by a target terminal 220. Accordingly, the terminal 210 may estimate a relative direction θ based on the route information of the terminal 210 and the route information of the target terminal 220.

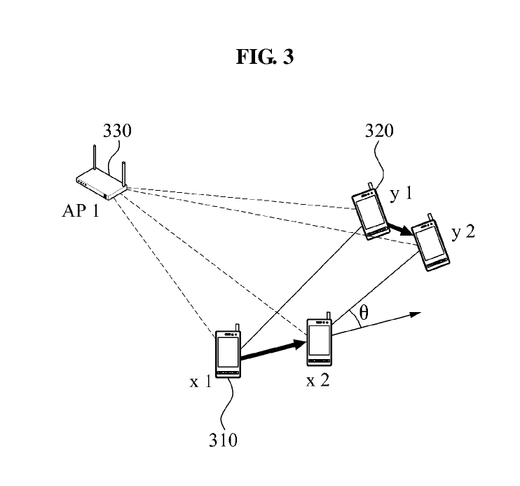

FIG. 3 illustrates a second example of estimating a relative direction.

Referring to FIG. 3, a terminal 310 may estimate route information of the terminal 310, for example, a moving distance and a moving direction of the terminal 310. For example, the terminal 310 may estimate a distance from an access point (1) (AP (1)) 330 that corresponds to a reference device at a predetermined time interval. For example, the terminal 310 may estimate a distance and a moving direction from a position x(1) to a position x(2), a distance between the position x(1) and the position AP (1) 330, and a distance between the position x(2) and the AP (1) 330.

As another example, a terminal 320 may estimate route information of the terminal 320, for example, a distance and a moving direction from a position y(1) to a position y(2), a distance between the position y(1) and the position AP (1) 330, and a distance between the position y(2) and the AP (1) 330.

The terminal 310 may receive the estimated distance and the estimated moving direction of the terminal 320 from position y(1) to position y(2), the distance between the position y(1) and the AP (1) 330, and the distance between the position y(2) and the AP (1) 330 that correspond to route information estimated by the target terminal 320. Accordingly, the terminal 310 may estimate a relative direction 0 based on the route information of the terminal 310 and the route information of the target terminal 320.

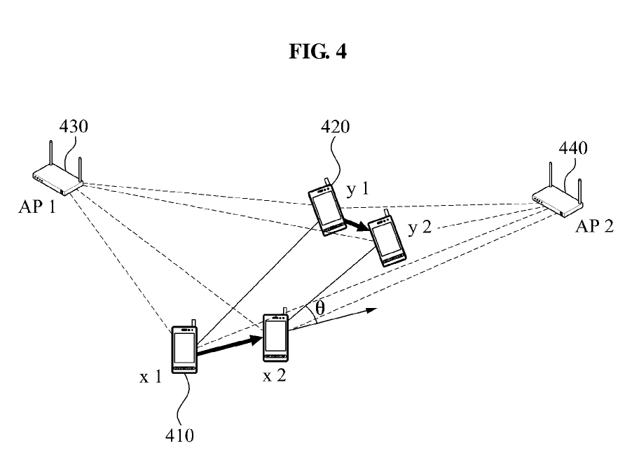

FIG. 4 illustrates a third example of estimating a relative direction.

Referring to FIG. 4, a terminal 410 may estimate route information, for example, a moving distance and a moving direction of the terminal 410. For example, the terminal 410 may estimate a distance from an AP (1) 430 and an AP (2) 440 that correspond to reference devices at predetermined time intervals. The terminal 410 may estimate a distance and a moving direction of the terminal 410 from a position x(1) to a position x(2), a distance between the position x(1) and the AP (1) 430, a distance between the position x(1) and the AP (2) 440, a distance between the position x(2) and the AP (1) 430, and a distance between the position x(2) and the AP (2) 440.

The terminal 410 may receive route information of a target terminal 420. The route information of the target terminal 420 may be estimated using the same scheme used for estimating the route information of the terminal 410 based on the distance and moving direction of the terminal 420 from y(1) to y(2).

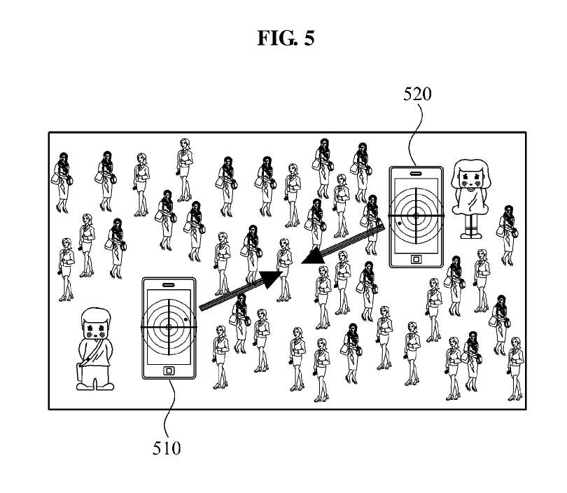

The terminal 410 may estimate a relative direction θ based on the route information of the terminal 410 and the route information of the target terminal 420. Accordingly, the terminal 410 may estimate an angle at which the target terminal 420 is moving with respect to the terminal 410. For example, a location estimator of the terminal 410 may estimate a relative location of the target terminal based on information about a relative distance from the target terminal and a relative direction to the target terminal. For example, the location estimator may output the relative location of the target terminal in radar form through a display unit of the terminal 410. An example of displaying the relative location of the target terminal in radar form is illustrated in FIG. 5.

FIG. 5 illustrates an example of estimating a relative location in a crowd.

Referring to FIG. 5, users of two terminals 510 and 520 may estimate relative locations of each other in the crowd. For example, the user of terminal 510 may estimate the relative location of terminal 520, and vice versa. A screen may display the estimated relative locations of the terminals 510 and 520 as a relative distance from a direction of the other terminal in radar form.

Referring again to FIG. 1, for example, when an absolute location of one of terminal 100 and a target terminal is verifiable, the location estimator 118 may estimate an absolute location of the other terminal based on the estimated relative location of one of the terminal 100 and the target terminal. As another example, when an absolute location of the terminal 100 is verifiable, the location estimator 118 may estimate an absolute location of the target terminal based on the estimated relative location of the target terminal As another example, when an absolute location of the target terminal is verifiable, the location estimator 118 may estimate an absolute location of the terminal 100 based on the estimated relative location of the target terminal.

The control unit 110 may control the overall operations of the terminal 100. For example, the control unit 110 may control the distance estimator 112, the route information collector 114, the direction estimator 116, and/or the location estimator 118. As another example, the control unit 110 may perform a function of at least one of the distance estimator 112, the route information collector 114, the direction estimator 116, and the location estimator 118. Functions of the above constituent components are separately illustrated to describe each of the functions distinctively. Accordingly, when a product is manufactured, all the functions may be configured to be processed by the control unit 110, alternatively, one or more of the functions may be configured to be processed by the control unit 110.

Hereinafter, a method for estimating a relative location according to the aspects above is described with reference to a figure.

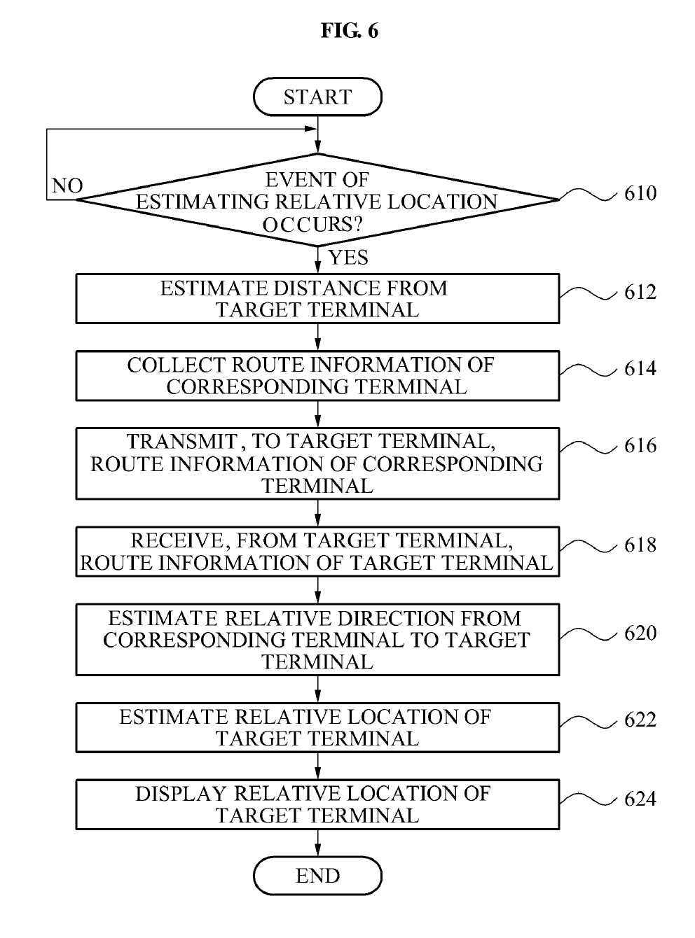

FIG. 6 illustrates an example of a method of estimating a relative location.

Referring to FIG. 6, when a terminal detects that an event of estimating a relative location occurs, in 610, the terminal estimates a distance from a target terminal, in 612. For example, the distance from the target terminal may be estimated based on a TOA, a TDOA, an RSSI, and the like.

The terminal collects route information of the terminal, in 614. For example, the route information of the terminal may include moving distance information and moving direction information of the terminal. When a reference device exists around the terminal, a distance from the reference device at a predetermined time interval may be included in the route information of the terminal.

The terminal transmits the collected route information of the terminal to the target terminal, in 616. The terminal receives, from the target terminal, route information of the target terminal, in 618.

In 620, the terminal estimates a relative direction from the terminal to the target terminal based on the route information of the terminal and the route information of the target terminal. For example, the relative direction may be estimated using an algorithm of an extended Kalman filter, an unscented Kalman filter, a particle filter, and the like that correspond to a statistical inference scheme.

The terminal estimates a relative location of the target terminal based on the relative distance from the target terminal and the relative direction to the target terminal, in 622. The terminal displays the estimated relative location of the target terminal, in 624. For example, the terminal may display the relative location of the target terminal in radar form as illustrated in FIG. 5.

Described herein is a method and apparatus for estimating a distance from the apparatus to a target terminal, collecting route information of the apparatus and route information of the target terminal, and estimating a relative location to the target terminal based on route information of the apparatus and the route information of the target terminal. For example, when map information does not exist, and a distance from a reference position where an absolute coordinate is known is not verified, a relative location to the target terminal may be estimated.

As a non-exhaustive illustration only, the terminal device described herein may refer to mobile devices such as a cellular phone, a personal digital assistant (PDA), a digital camera, a portable game console, an MP3 player, a portable/personal multimedia player (PMP), a handheld e-book, a portable lab-top personal computer (PC), a global positioning system (GPS) navigation, and devices such as a desktop PC, a high definition television (HDTV), an optical disc player, a setup box, and the like, capable of wireless communication or network communication consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It should be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

The methods, processes, functions, and software described above may be recorded, stored, or fixed in one or more computer-readable storage media that includes program instructions to be implemented by a computer to cause a processor to execute or perform the to program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for estimating a relative location, the apparatus comprising:
a distance estimator to estimate a distance from the apparatus to a target terminal;
a route information collector to collect route information of the apparatus; and
a direction estimator to receive, from the target terminal, route information of the target terminal, and to estimate a relative direction from the apparatus to the target terminal based on the route information of the apparatus and the route information of the target terminal.

2. The apparatus of claim 1, wherein the distance estimator transmits the estimated route information of the apparatus to the target terminal.

3. The apparatus of claim 1, wherein the distance estimator estimates the distance from the target terminal based on at least one of a time of arrival (TOA), a time difference of arrival (TDOA), and a received signal strength indication (RSSI).

4. The apparatus of claim 1, further comprising:
a sensor unit to measure a moving velocity and a moving direction of the apparatus,
wherein, using the sensor unit, the route information collector collects, as the route information of the apparatus, moving distance information and moving direction information of the apparatus at a predetermined time interval.

5. The apparatus of claim 4, wherein:
the distance estimator estimates a distance from a reference device when the reference device exists around the apparatus, and
the route information collector collects, as the route information of the apparatus, the distance from the reference device.

6. The apparatus of claim 1, further comprising:
a sensor unit to measure surrounding environment information of the apparatus,
wherein the route information collector collects, as the route information of the apparatus, the surrounding environment information measured using the sensor unit.

7. The apparatus of claim 6, wherein the direction estimator estimates a relative direction to the target terminal by comparing the surrounding environment information included in the route information of the apparatus with surrounding environment information included in the route information of the target terminal.

8. The apparatus of claim 1, wherein the direction estimator estimates the relative direction to the target terminal using at least one algorithm of an extended Kalman filter, an unscented Kalman filter, and a particle filter that correspond to a statistical inference scheme.

9. The apparatus of claim 1, further comprising:
a location estimator to estimate a relative location from the apparatus to the target terminal based on the relative distance from the target terminal and a relative direction to the target terminal; and
a display unit to display the estimated relative location of the target terminal.

10. The apparatus of claim 9, wherein the location estimator controls the relative location of the target terminal based on the apparatus to be displayed in radar form on the display unit.

11. The apparatus of claim 9, wherein, when an absolute location of the apparatus is verifiable, the location estimator estimates an absolute location of the target terminal based on the estimated relative location of the target terminal.

12. The apparatus of claim 9, wherein, when an absolute location of the target terminal is verifiable, the location estimator estimates an absolute location of the apparatus based on the estimated relative location of the target terminal.

13. A method for estimating a relative location, the method comprising:
estimating a distance from a target terminal to an apparatus;
collecting route information of the apparatus;
receiving, from the target terminal, route information of the target terminal; and
estimating a relative direction from the apparatus to the target terminal based on the route information of the apparatus and the route information of the target terminal.

14. The method of claim 13, further comprising:
transmitting, to the target terminal, the estimated route information of the apparatus.

15. The method of claim 13, wherein the estimating of the distance from the target terminal comprises estimating the distance from the target terminal based on at least one of a TOA, a TDOA, and an RSSI.

16. The method of claim 13, wherein the collecting comprises collecting, as the route information of the apparatus, moving distance information and moving direction information of the apparatus at a predetermined time interval.

17. The method of claim 16, wherein when a reference device exists around the apparatus, the collecting comprises collecting, as the route information of the apparatus, a distance from the reference device for a predetermined time interval.

18. The method of claim 13, wherein the collecting comprises collecting, as the route information of the apparatus, the surrounding environment information measured using a sensor unit.

19. The method of claim 18, wherein the estimating of the relative direction to the target terminal comprises estimating the relative direction to the target terminal by comparing the surrounding environment information included in the route information of the apparatus with surrounding environment information included in the route information of the target terminal.

20. The method of claim 13, wherein the estimating of the relative direction to the target terminal comprises estimating the relative direction to the target terminal using at least one algorithm of an extended Kalman filter, an unscented Kalman filter, and a particle filter that correspond to a statistical inference scheme.

21. The method of claim 13, further comprising:
estimating a relative location from the apparatus to the target terminal based on the relative distance from the target terminal and a relative direction from to the target terminal; and
displaying the estimated relative location of the target terminal.

22. The method of claim 21, wherein the displaying comprises displaying the relative location of the target terminal based on the apparatus in radar form.

23. The method of claim 21, further comprising:
estimating an absolute location of the target terminal based on the estimated relative location of the target terminal, when an absolute location of the apparatus is verifiable.

24. The method of claim 21, further comprising:
estimating an absolute location of the apparatus based on the estimated relative location of the target terminal, when an absolute location of the target terminal is verifiable.
